(19) United States
(12) Patent Application Publication
(10) Pub. No.: US 2019/0106936 A1
(43) Pub. Date: Apr. 11, 2019

(54) Rebound Device Used In Running A Pull Cord

(71) Applicants: Yu-Wei Huang, Taipei City (TW); Anli Spring Co., Ltd., Taipei City (TW)

(72) Inventors: Ta-Peng Huang, Taipei City (TW); Yu-Wei Huang, Taipei City (TW)

(21) Appl. No.: 15/873,875

(22) Filed: Jan. 17, 2018

(30) Foreign Application Priority Data
Oct. 5, 2017 (TW) 106214821

(51) Int. Cl. E06B 9/322

(52) U.S. Cl. CPC E06B 9/322; E06B 2009/3227

(57) ABSTRACT

A rebound device used in running a pull cord provides for a retractable unit of a window blind to switch reversely a winding angle of the pull cord, upon rolling up the pull cord onto an inner radial side of a reel. The rebound device with an elastic action is disposed in the retractable unit opposite to an access opening of the reel, and includes an elastic tensile element or a gate-front shear set with an elastic function. In rolling up the pull cord, the pull cord is wound onto a coil on the wheel surface of the reel and after the pull cord is wound onto a coil on the inner radial side, the rebound action of the rebound device switches the pull cord reversely, allowing a new layer of winding coil to be wound reversely and orderly, so that the coil can be wound orderly in layers.

### FIELD OF THE INVENTION

The present invention relates to a rebound device used in running a pull cord, and more particularly to a rebound device that provides for a retractable unit of a window blind to make the pull cord comply with a winding passage, while rolling up the pull cord.

### BACKGROUND

Referring to FIG. 1, it shows a window blind 10 without exposing a pull cord 40. The pull cord 40 passes through slats 12, and a lower end of the pull cord 40 is combined on a bottom rail 13; whereas an upper end of the pull cord 40 enters into a top rail 11 and is connected with a reel 30 of a retractable unit 20. The reel 30 is a self-operated feedback system (spring motor) and stores elastic feedback force when the slats 12 are being rolled down. On the other hand, when the slats 12 are to be retracted, the bottom rail 13 is touched and the static friction force is removed, and then the reel 30 will form the output energy of feedback to roll up the pull cord 40.

The traditional reel 30 performs the rolling action directly from the wheel surface and the pull cord 40, and the order by which the coil 400 is wound will be normally rambled while rolling up the pull cord 40, as shown in FIG. 2.

Referring to FIG. 2 again, the pull cord 40 enters into the retractable unit 20 via an access opening 21 and is wound on the reel 30. In particular, when rolling up the pull cord 40, the pull cord 40 will be wound in many turns on a passage in same height due to the change in the friction force resulted from the shearing onto the inner coil by a rebound coil 401. Therefore, as shown in the drawing, the upper end of the coil 400 will be wound into many overlapped strands, and can be wound reversely toward a center of the wheel surface of the reel 30 only when the friction force on the inner coil caused by the rebound coil 401 is changed. This problem will cause the bottom rail 13 (as shown in FIG. 1) to ascend in a different speed that the bottom rail 13 may be inching or bouncing. In addition, noise may appear and texture may be lost during the entire rolling process.

### SUMMARY OF THE INVENTION

An object of the present invention is to provide a rebound device used in running a pull cord. The rebound device provides for the retractable unit of a window blind to switch automatically the winding passage of the pull cord during the rolling process, wherein an interior of the retractable unit, opposite to an access opening of the reel, is provided at least with a rebound device for performing an elastic action. The rebound device is provided with an elastic tensile element or a gate-front shear set with an elastic function, so that during the process of the reel rolling up the pull cord, the pull cord is wound into the coil on the wheel surface of the reel, and after the pull cord is wound into an inner radial coil, by the rebound action of the rebound device, the section of the pull cord that is acted upon to enter into the access opening can drive reversely a first winding for a new layer of the pull cord, so that the pull cord can be switched reversely, which enables the subsequent winding to exit from the inner radial direction of shear that the pull cord can be wound reversely on the wheel surface of the reel and can be rolled up orderly.

A second object of the present invention is to provide a rebound device used in running a pull cord, wherein two ends of the elastic tensile element are provided with a top pressing end and a suppression end, facing respectively the end surface of the shear pulley as well as the upper and lower inner surface of the access opening.

A third object of the present invention is to provide a rebound device used in running a pull cord, wherein the elastic tensile element is a helical structure or a disk-shaped structure and is provided with a top pressing end and a suppression end, with a central hole in the center. The top pressing end and the suppression end are configured respectively on the end surface of the shear pulley.

A fourth object of the present invention is to provide a rebound device used in running a pull cord, wherein the rebound device is an elastic gate-front shear set which is disposed transversally on the upper and lower inner surface of the access opening to shear the pull cord elastically and reversely by the elastic function, thereby switching the pull cord reversely.

A fifth object of the present invention is to provide a rebound device used in running a pull cord, wherein the gate-front shear set can be a U-shaped body or an elastic block, with a portion at the apex being able to bear with the friction of the pull cord.

A sixth object of the present invention is to provide a rebound device used in running a pull cord, wherein an elastic shear tie can be a roller which frictions movably with the pull cord, with the elastic force being resulted from an elastic arm.

A seventh object of the present invention is to provide a rebound device used in running a pull cord, wherein the gate-front shear set is an elastic wire which forms a U-shaped half-frame unit by winding.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a front view of structures of a conventional window blind.

FIG. 2 shows a schematic view of a winding state of a conventional coil.

FIG. 3 shows a schematic view of an operation of a shear pulley relative to a pull cord, according to the present invention.

FIG. 4 shows a schematic view of structure of the shear pulley being implemented on an access opening, according to the present invention.

FIG. 5 shows a side view of an elastic tensile element, according to the present invention.

FIG. 6 shows a schematic view of a rebound device of the elastic tensile element, according to the present invention.

FIG. 7 shows a schematic view of a disk-shaped elastic tensile element, according to the present invention.

FIG. 8 shows a schematic view of the rebound device being implemented as the elastic tensile element, according to the present invention.

FIG. 9 shows a state view of operation of the rebound device that is implemented as the elastic tensile element, according to the present invention.

FIG. 10 shows a schematic view of a gate-front shear set, according to another implementation of the present invention.

FIG. 11 shows a schematic view of the gate-front shear set that is implemented as another elastic shear tie, according to the present invention.

FIG. 12 shows a side view of the implementation in FIG. 10.

FIG. 13 shows a state view of implementation in FIG. 11.

FIG. 14 shows a schematic view of anther implementation of the elastic shear tie, according to the present invention.

FIG. 15 shows another schematic view of another implementation of the elastic shear tie, according to the present invention.

FIG. 16 shows still another schematic view of another implementation of the elastic shear tie, according to the present invention.

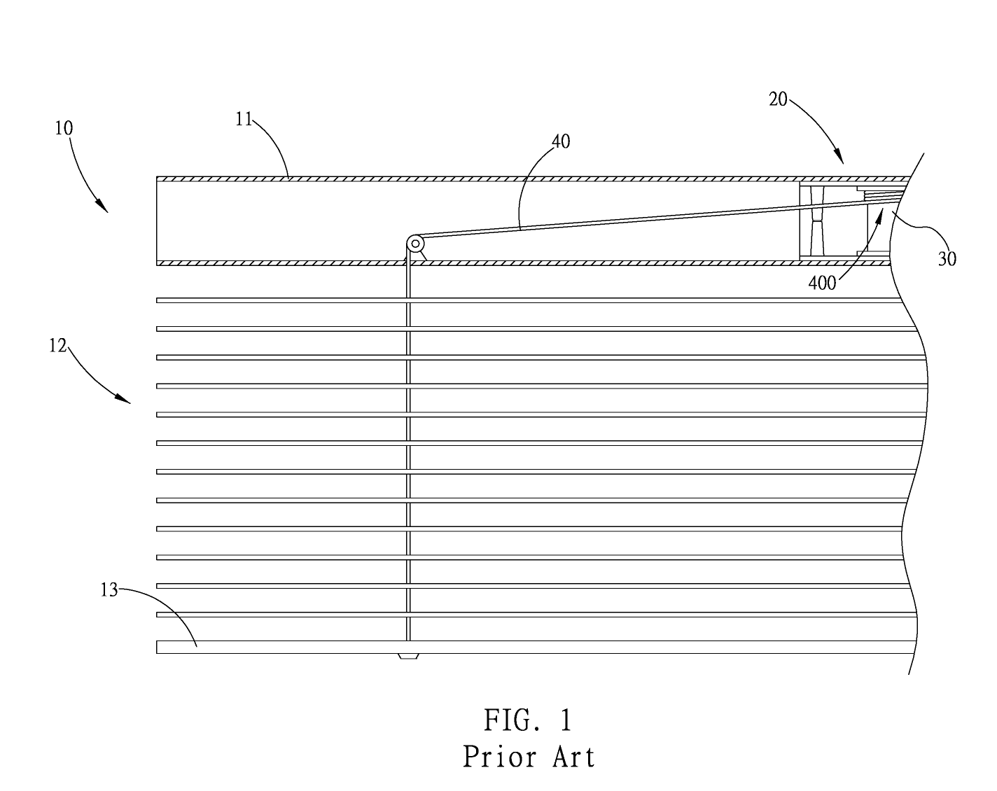

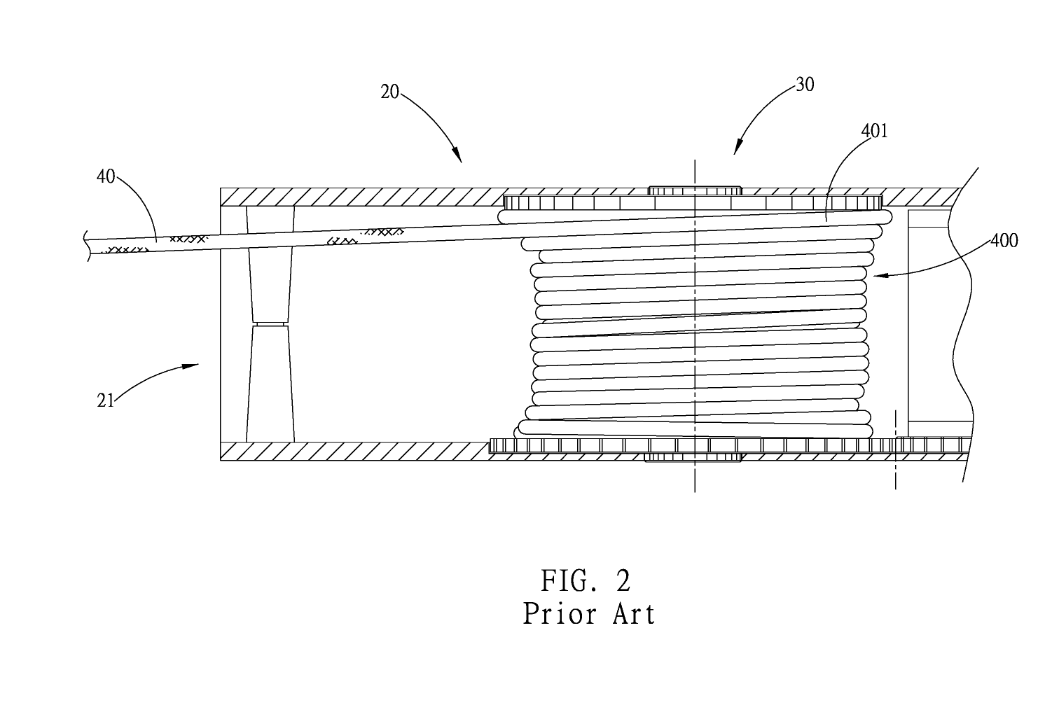

### DETAILED DESCRIPTION OF THE PREFERRED EMBODIMENTS

A rebound device used in running a pull cord provides for a retractable unit of a window blind to switch reversely the winding passage of the pull cord while rolling up the pull cord. An interior of the retractable unit, opposite to an access opening of the reel, is provided at least with a rebound device for performing an elastic action. For the implementation of the reel of the retractable unit, if the axis of the reel is parallel to a ground vertical line, a set of rebound device is disposed at the access opening below the pull cord. On the other hand, if the axis of the reel is parallel to a ground horizontal line, two sides of the access opening are provided respectively with a rebound device (to simplify the description, the implementation of one or two sets of the rebound device is disclosed below and therefore will not be described further).

The abovementioned rebound device is provided with an elastic tensile element or a gate-front shear set with an elastic function which enables the reel to wind the pull cord into a coil on the wheel surface of the reel while rolling up the pull cord. After the pull cord is wound into an inner radial coil, the running passage of the pull cord can be switched reversely by the rebound action of the rebound device, allowing a new layer in the outermost coil to be wound reversely in order.

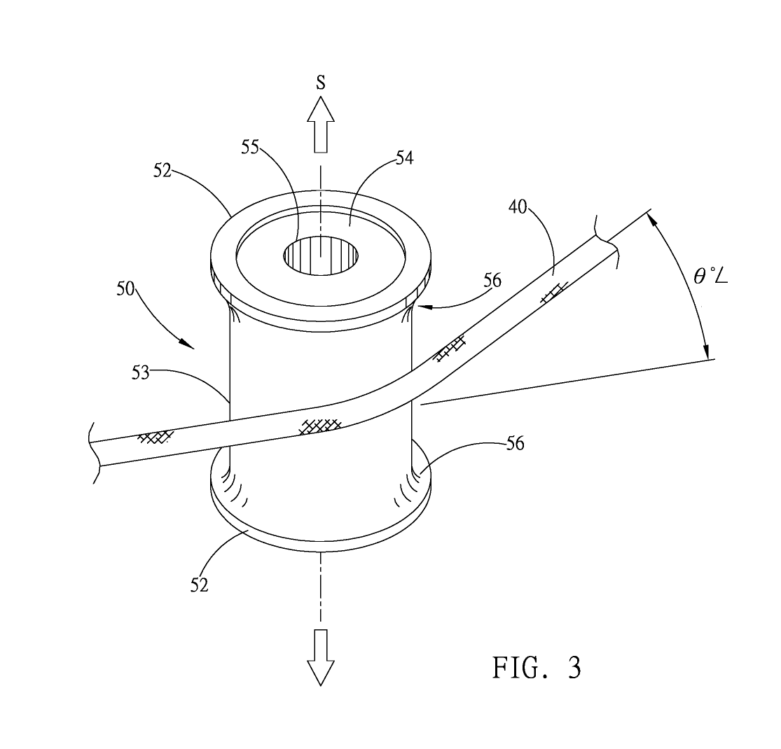

There are two embodiments of the present invention. The first embodiment is shown in FIGS. 3 to 9. First of all, referring to FIG. 3, a circumference 53 of a shear pulley 50 provides for a pull cord 40 to pass by in a tangential direction, and to friction slidingly within the height of the wheel surface. The shear pulley 50 is provided with a shaft hole 55 which rotates against an axis S. Two ends of the shear pulley 50 are provided respectively with a spoke 52, an outer end of the spoke 52 is an end surface 54, and the upper and lower boundary of the pull cord 40 are limited by an inner supporting angle 56 at an intersection between the spoke 52 and the circumference 53.

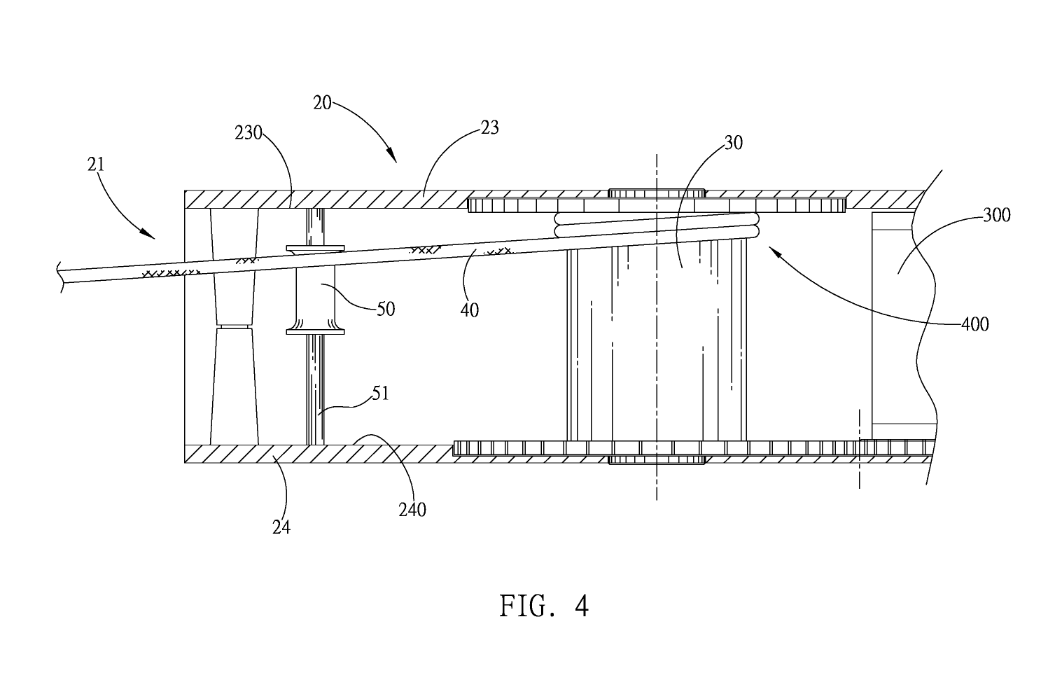

Referring to FIG. 4, an interior of the retractable unit 20 is implemented with a shear pulley 50 which is slidingly disposed on a pillar 51. Two ends of the pillar 51 are combined vertically on the upper and lower inner surface 230, 240 of the access opening 21. The access opening 21 is formed by an upper frame 23 and a lower frame 24 which face each other parallel in the vertical direction. The reel 30 is parallel to the axis of the pillar 51. After the pull cord 40 passes through the access opening 21 and shears the shear pulley 50, the pull cord 40 is wound on the surface of the reel 30 into a coil 400. Upon rolling up the pull cord 40, the power of the reel 30 comes from a power wheel 300 which is a power unit to store elastic energy, such as a spring motor, a unit which converts electricity into power, or a manual unit which drives the reel 30 indirectly.

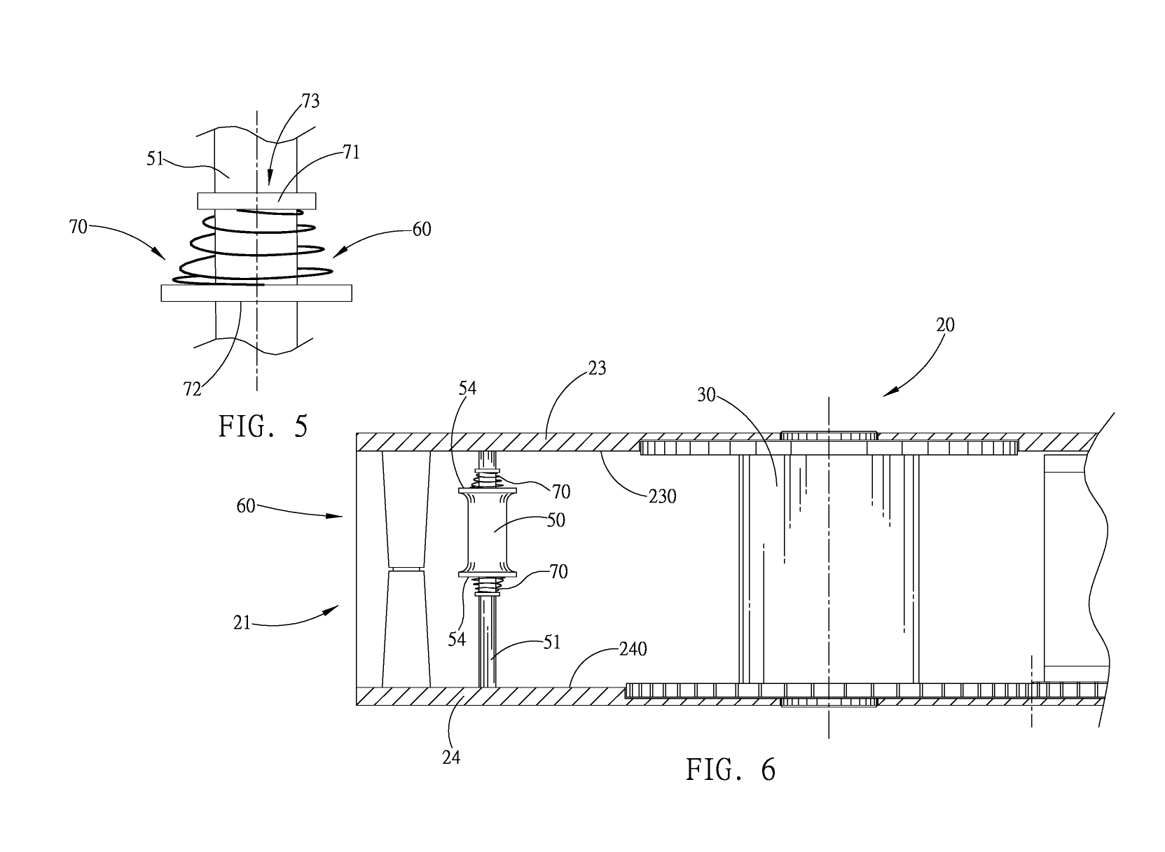

Referring to FIG. 5, the rebound device 60 of the present invention is implemented at least with an elastic tensile element 70 which is a helical spring unit. A center of the elastic tensile element 70 is a central hole 73 which is loosely sheathed with the pillar 51. An upper end and a lower end of the elastic tensile element 70 are provided respectively with a top pressing end 71 and a suppression end 72. The center of axis of the elastic tensile element 70 is provided with a central hole 73 which slides on the pillar 51 axially.

Referring to FIG. 6, the rebound device 60 of the present invention is implemented at the access opening 21 of the retractable unit 20, and a shear pulley 50 is disposed slidingly on the pillar 51. One or both of the upper end and the lower end of the shear pulley 50 is engaged with the elastic tensile element 70 which can be fixedly combined on the end surface 54, move freely, or be combined on the upper and lower inner surface 230, 240 of the access opening 21.

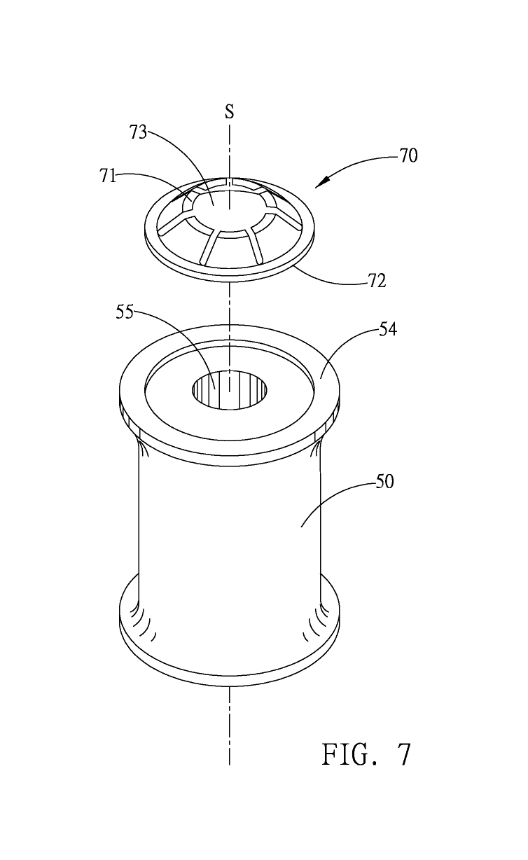

Referring to FIG. 7, the elastic tensile element 70 is a disk-shaped body, with a central hole 73 in the center of axis. The upper end and the lower end of the elastic tensile element 70 are provided with a top pressing end 71 and a suppression end 72. The diameter of the central hole 73 is a little larger than or equal to that of the shaft hole 55. The suppression end 72 can be combined on the end surface 54 or move relative to the end surface 54. The diameter of the outer circumference of the suppression end 72 is smaller than the diameter of the end surface 54 of the shear pulley 50.

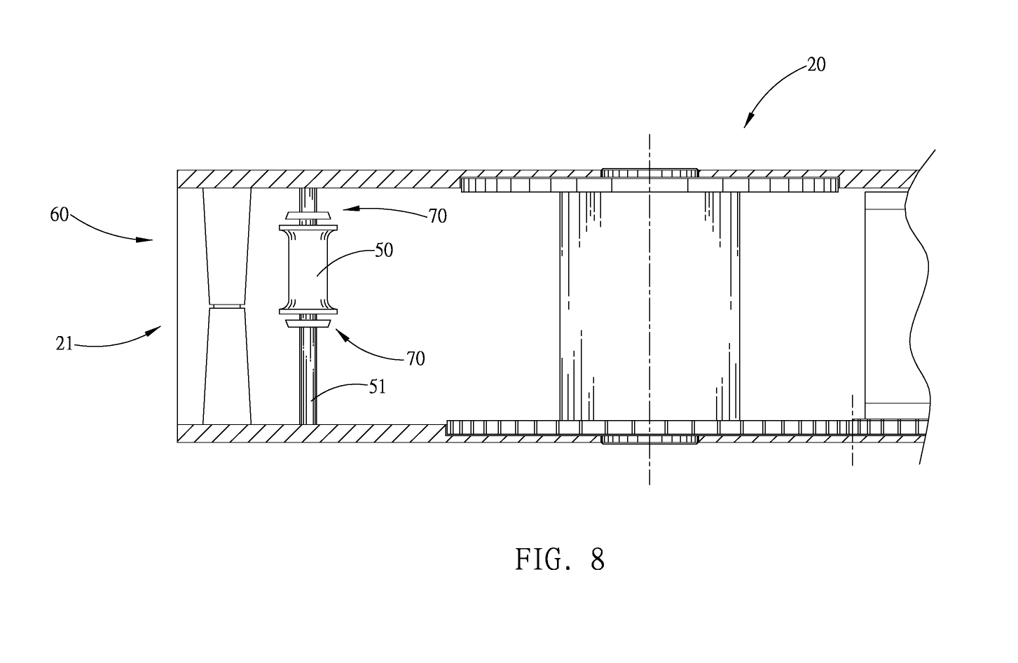

Referring to FIG. 8, one or two of the disk-shaped elastic tensile element 70 implemented by the rebound device 60 is combined optionally on one or two ends of the shear pulley 50, and is slidingly disposed on the pillar 51, forming the basis of the retractable unit 20 with the automatic rebound function.

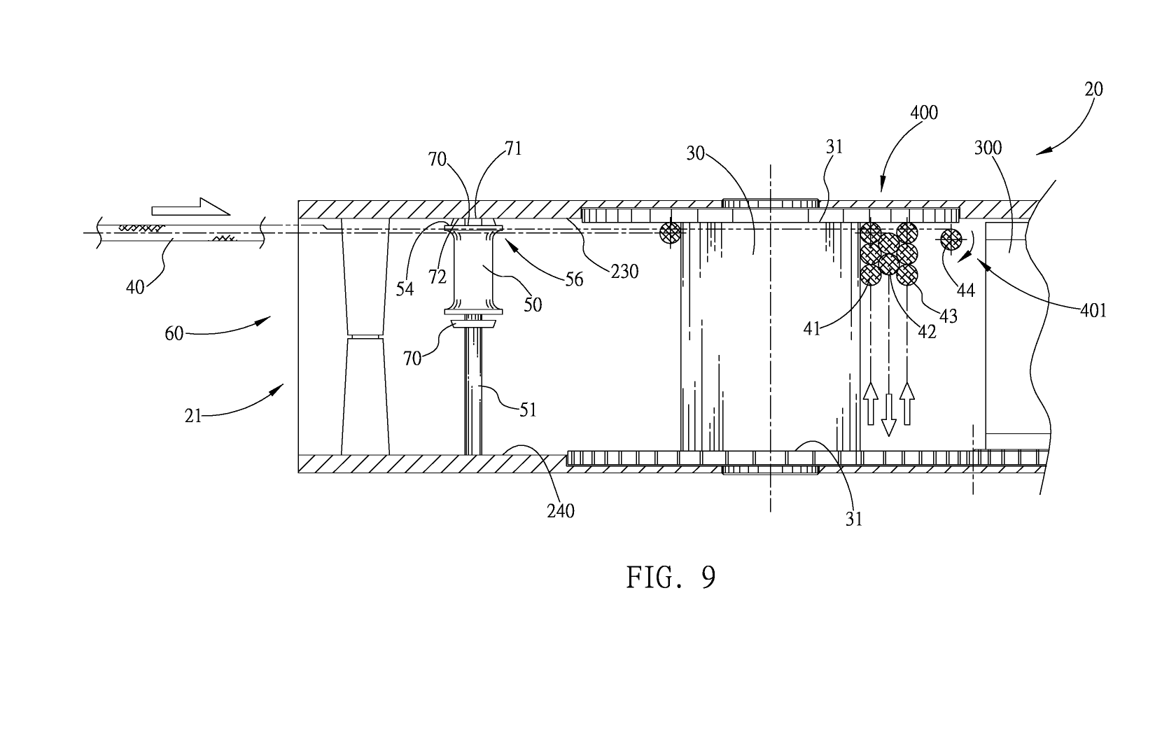

As shown in FIG. 9, the reel 30 of the retractable unit 20 rolls up the pull cord 40. During winding and retracting, the pull cord 40 will be wound on the outer circumference of the reel 30 to form the coil 400. Depending upon the accumulation of winding, the coil 400 is formed with a first layer of winding coil 41, a second layer of winding coil 42, a third layer of winding coil 43, and a fourth layer of winding coil 44 which is the rebound coil 401 at the outmost layer in this embodiment. The first layer of winding coil 41, the second layer of winding coil 42, and the third layer of winding coil 43 are wound alternatingly, with that the first layer of winding coil 41 is wound in a bottom-up direction, the second layer of winding coil 42 is wound in a top-down direction, and the third layer of winding coil 43 is wound in a bottom-up direction. Therefore, the fourth layer of winding coil 44 is to be wound from top to bottom. In the present invention, the switch function starts at the second layer of winding coil 42 (this drawing shows that the fourth layer of winding coil 44 is in the operation condition). In order to allow the fourth layer of winding coil 44 (the rebound coil 401) to exit from the inner radial side 31 of the reel 30 to be wound downward, the surface of the pull cord 40 that passes through the reel 30 tangentially is latched by the inner supporting angle 56. In addition, by the elastic tensile element 70 on the upper end of the shear pulley 50 of the rebound device 60, the elastic force will be acted parallel to the axis of the reel 30, forming an elastic suppression action in a reverse direction that the end surface 54 of the shear pulley 50 will be pressed on by the suppression end 72, and the upper inner surface 230 of the access opening 21 will be pressed on by the top pressing end 71. By the swelling force, the shear pulley 50 will be pushed downward, which links the inner supporting angle 56 to push the pull cord 40 that slides tangentially in a downward direction. Therefore, the rebound coil 401 will enter downward into an included angle between two neighboring strands of the third layer of winding coil 43, forming a compliance of the switch in direction, so that the winding direction of the fourth layer of winding coil 44 can be switched reversely according to the request of the direction of winding, and the fourth layer of winding coil 44 can be wound from top to bottom, thereby rolling up the pull cord 40 forwardly. On the other hand, the fourth layer of winding coil 44 is wound downward sequentially, and the pull cord 40 thereof will reach finally the inner radial side 31 on the lower end of the reel 30. As the abovementioned working principle, the lower inner surface 240 will be pressed on by the elastic tensile element 70 on the lower end of the shear pulley 50, forming the elastic tensile force to push up the pull cord 40 again, thereby achieving the alternating collection of the pull cord 40. The location of the elastic counteraction formed by the abovementioned elastic tensile element 70 is within the span of the inner radial side 31 on two ends of the reel 30 and mainly acts to prepare the switching of the running passage of the pull cord 40 to result in the rebound coil 401.

By the elastic rebound force that can be formed on the upper and lower end of the rebound device 60, during the process that the pull cord 40 is wound to touch any inner radial side 31 of the reel 30, the rebound coil 401 can be switched reversely to achieve the winding of the coil 400 in the requested direction smoothly.

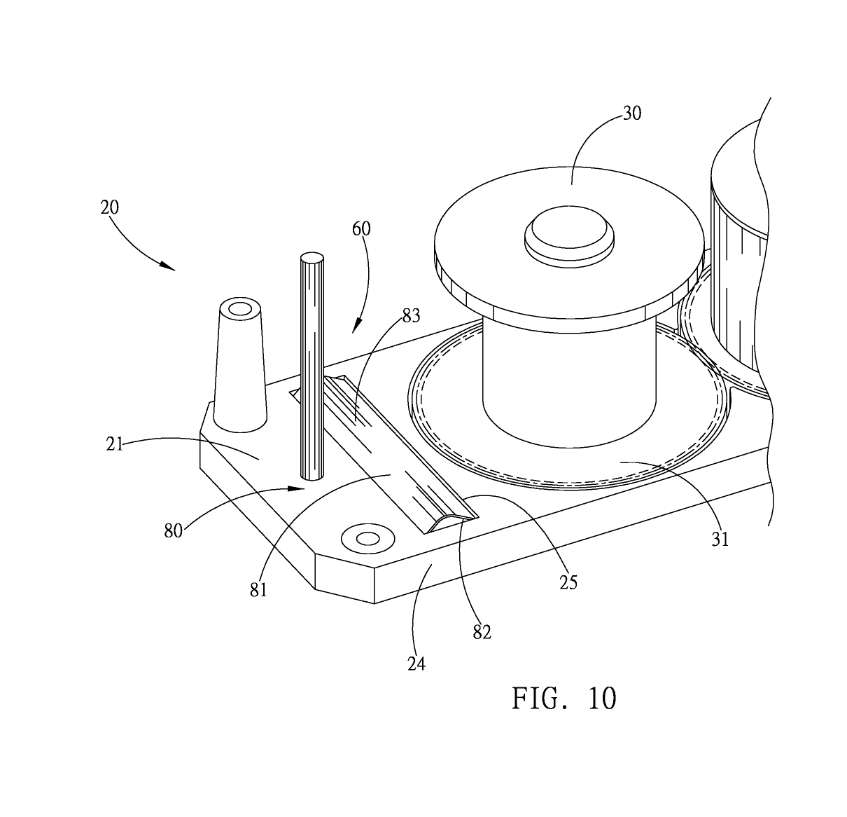

Referring to FIG. 10, another embodiment of the rebound device 60 of the present invention utilizes a gate-front shear set 80 with the elastic function. The gate-front shear set 80 is disposed on the surface of the access opening 21 (to simplify the description, this drawing shows that the gate-front shear set 80 is installed on the upper surface of the lower frame 24), and the elastic force is acted parallel to the axis of the reel 30. The upper surface of the lower frame 24 is part of the access opening 21, and the retractable unit 20 is similarly provided with a reel 30. In this embodiment, a transversal gate-front shear set 80 is disposed parallel to the outer side on the horizontal surface of the inner radial side 31, and the gate-front shear set 80 is protruded longitudinally to a highest point, forming a linear apex 83. At least a side of the gate-front shear set 80 is provided with an elastic arm 82 which is movably assembled in a slot 25 of the lower frame 24. Therefore, the rebound device 60 is formed step by step. The abovementioned apex 83 is located in tangential to the wheel surface of the reel 30, and the elastic counteraction is acted onto the wheel surface from the height of the wheel surface close to the inner radial side 31.

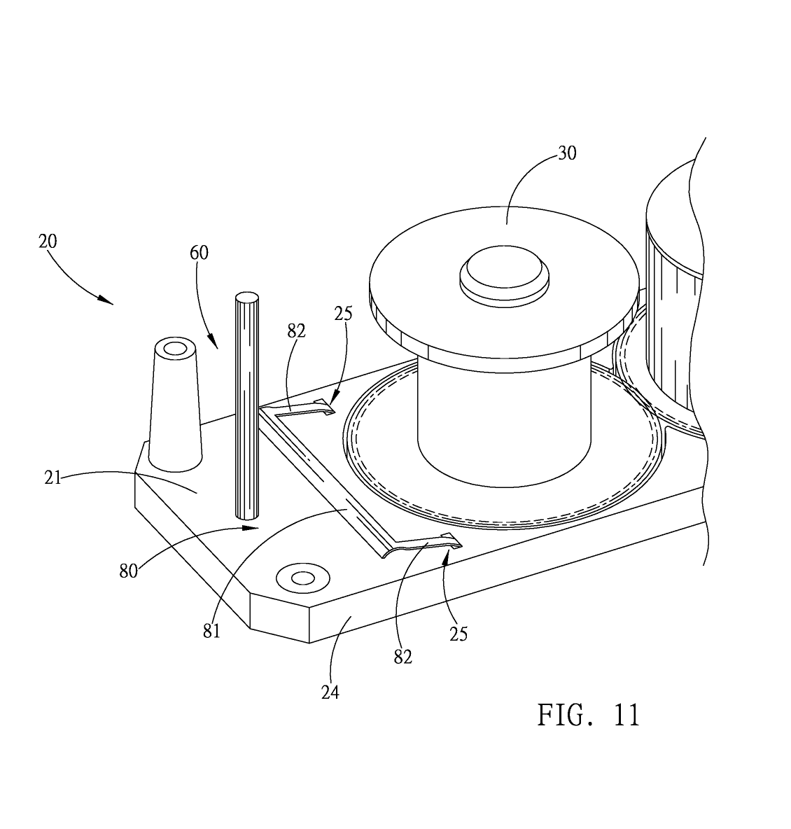

Referring to FIG. 11, the rebound device 60 of the retractable unit 20 is a gate-front shear set 80 which is a U-shaped elastic shear tie 81. Two sides of the elastic shear tie 81 are extended with an elastic arm 82 respectively, and a tail end of the elastic arm 82 is fixed in the slot 25 of the lower frame 24.

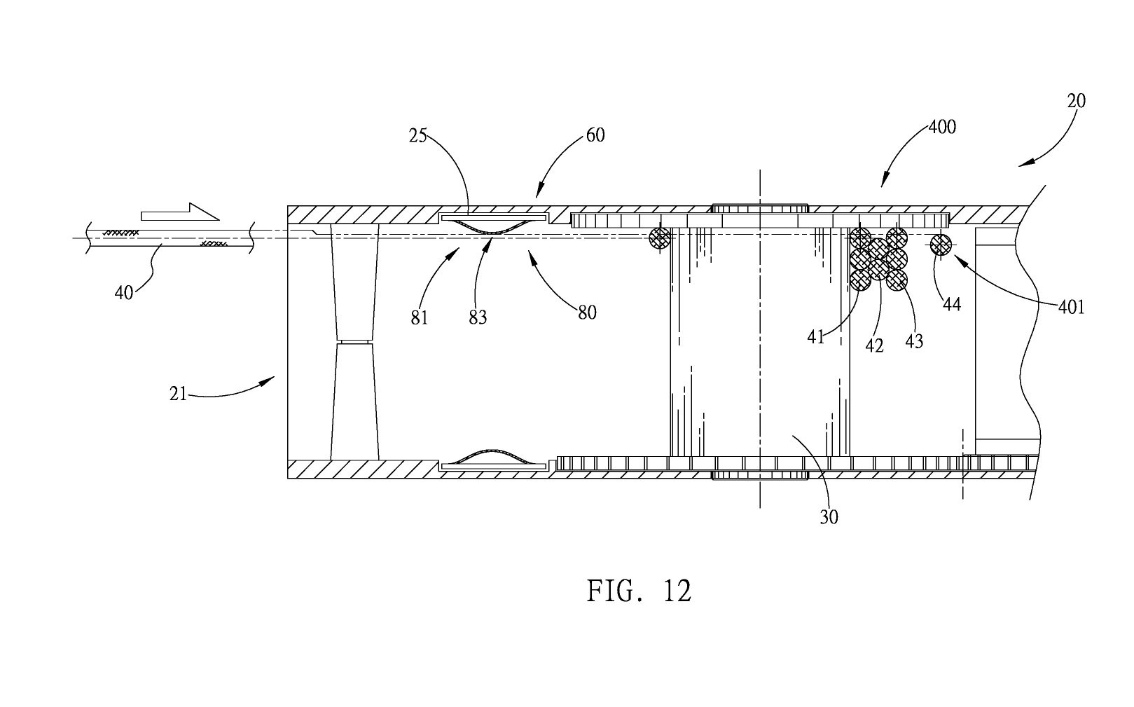

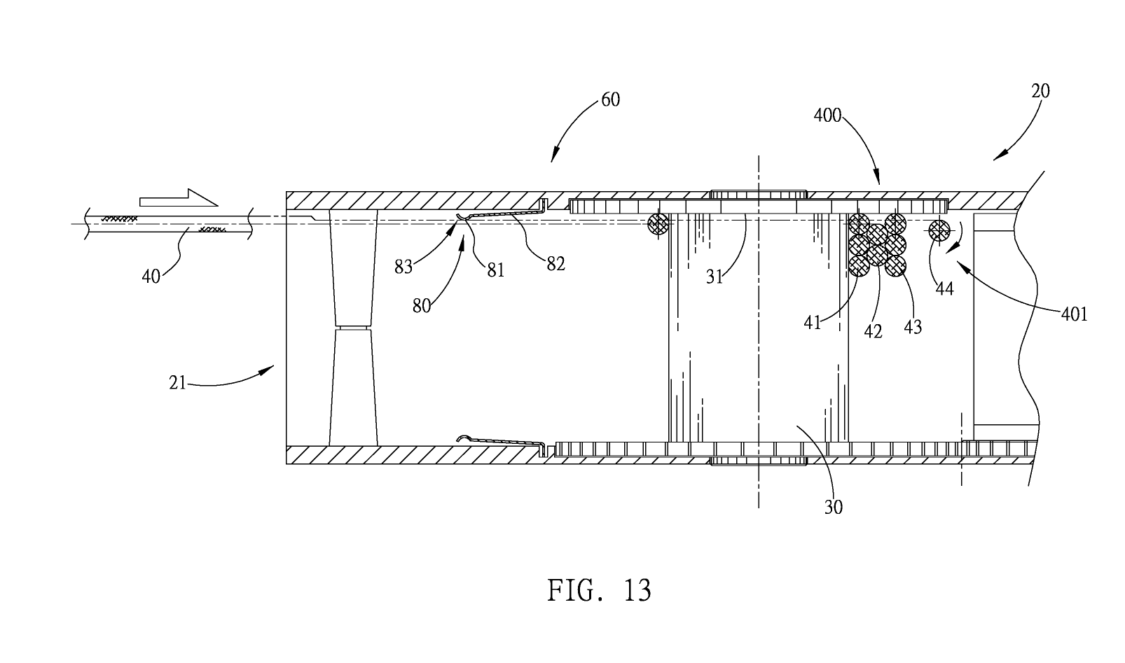

Referring to FIG. 12, the body of the pull cord 40 is sheared by the elastic apex 83, and while rolling up the pull cord 40, the fourth layer of winding coil 44 will be pushed reversely and elastically by the elastic shear tie 81 to rebound the pull cord 40 downward, which is the same as the condition shown in FIG. 9. In addition, the linear center of the pull cord 40 can be disposed in the included angle between two neighboring strands of the third layer of winding coil 43. This kind of design can simplify the structure of access opening 21 of the retractable unit 20. Referring to FIG. 13, the rebound device 60 is implemented as a gate-front shear set 80. The elastic arm 82 of the gate-front shear set 80 forms an elastic function to link the elastic shear tie 81, and the apex 83 of the elastic shear tie 81 shears the body of the pull cord 40. Being the same as the abovementioned working principle, when the fourth layer of winding coil 44 touches the inner radial side 31 of the reel 30, the reverse switch is formed, allowing the center of the rebound coil 401 to be aligned with the included angle of the adjacent third layer of winding coil 43, so that the coil 400 can be wound reversely and orderly. By this design of retractable unit 20, the space of the access opening 21 can be simplified, and this simplification can make the gate-front shear set 80 be in adjacent to the reel 30. Therefore, as the implementations shown in FIG. 12 and FIG. 13, the left and right length of the retractable unit 20 can be decreased, and the location of the apex 83 and the direction along which the apex 83 acts the elastic force are the same as those described in FIG. 10.

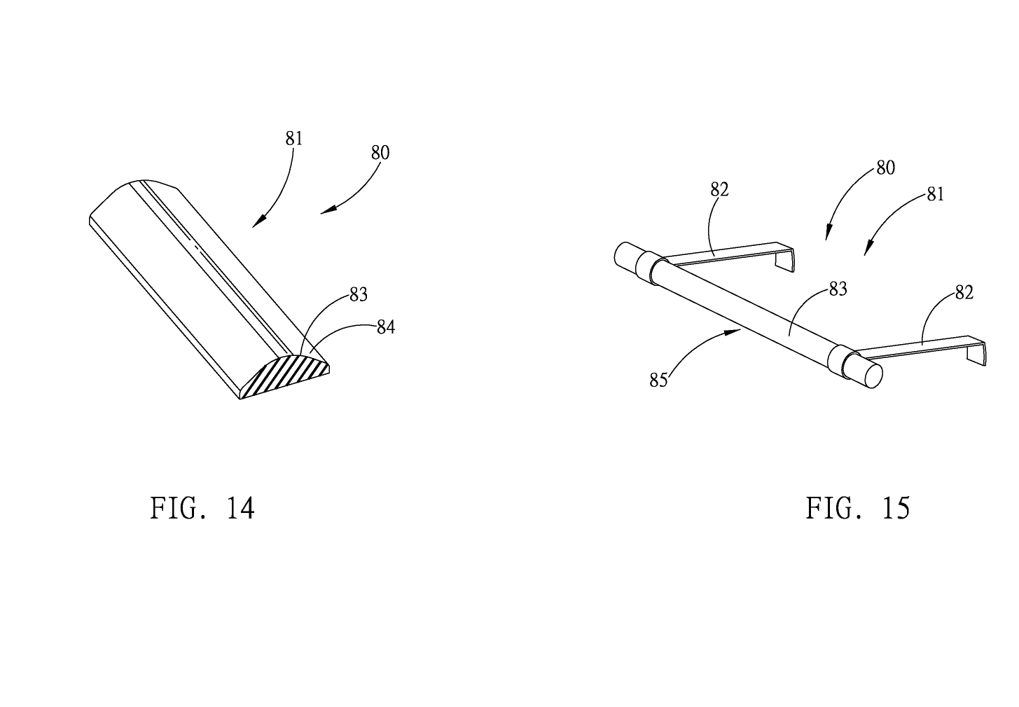

Referring to FIG. 14, the elastic shear tie 81 provided by the gate-front shear set 80 implemented by the present invention can be an elastic block 84, and the location of the apex 83 is designed to be wear resistant. Referring to FIG. 15, the gate-front shear set 80 is constituted by a roller 85, with two sides of which being connected respectively with an elastic arm 82. The elastic arms 82 perform an elastic function toward the roller 85, and the highest point on the outer surface of the roller 85 is formed with an apex 83. The roller 85 can be fixed with the elastic arms 82 or can rotate with respect to the elastic arms 82, forming specifically a U-shaped elastic shear tie 81.

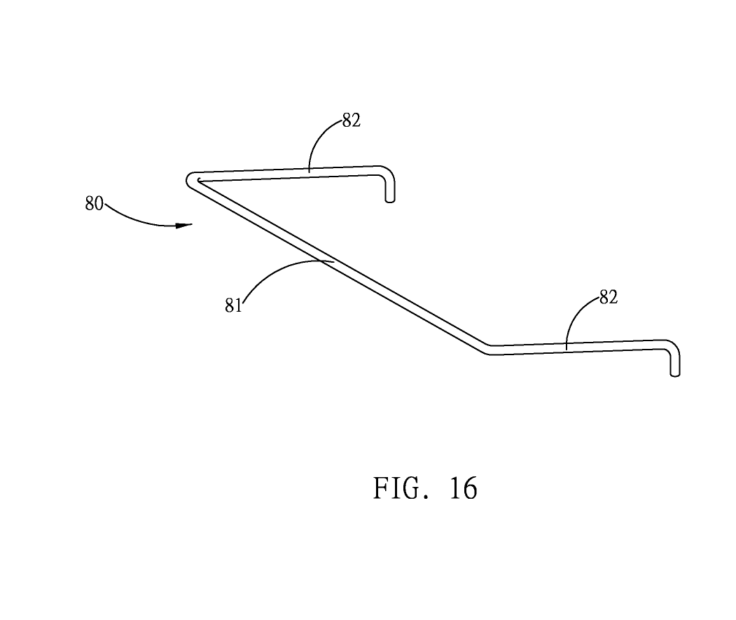

Referring to FIG. 16, the gate-front shear set 80 is made of an elastic metal wire and is wound into a U-shaped half-frame unit. The gate-front shear set 80 is transversally provided with the elastic shear set 81, with two sides being extended respectively with the elastic arm 82.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A rebound device used in running a pull cord, providing for a retractable unit of a window blind to make the pull cord comply with a winding passage while rolling up the pull cord, comprising a retractable unit which is provided with a reel and an access opening opposite to the working direction of the reel; and
a rebound device which is disposed in the access opening and includes a pillar, a shear pulley and an elastic tensile element; with that the pillar is disposed in the access opening parallel to the axis of the reel, two ends of the pillar are combined vertically on the upper and lower inner surface of the access opening respectively, the shear pulley is provided with a shaft hole and is movably disposed on the pillar, the elastic tensile element is axially provided with a central hole, is sheathed coaxially on the end surface of the shear pulley, and acts an elastic force parallel to the axis line of the reel.

2. The rebound device used in running a pull cord, according to claim 1, wherein two ends of the elastic tensile element are provided with a top pressing end and a suppression end, facing respectively the end surface of the shear pulley and the upper and lower inner surface of the access opening.

3. The rebound device used in running a pull cord, according to claim 2, wherein the access opening is a space formed by opposite side ends of an upper frame and a lower frame of the retractable unit.

4. The rebound device used in running a pull cord, according to claim 1, wherein the elastic tensile element is a helical structure.

5. The rebound device used in running a pull cord, according to claim 1, wherein the elastic tensile element is a disk-shaped structure.

6. A rebound device used in running a pull cord, providing for a retractable unit of a window blind to make the pull cord comply with a winding passage while rolling up the pull cord, comprising a retractable unit which is provided with a reel and an access opening opposite to the working direction of the reel; and
a rebound device which is disposed in the access opening and includes a gate-front shear set; with that the gate-front shear set is provided with an elastic shear tie with two arc-shaped cross sections, transversally disposed on the upper and lower inner surface of the access opening, the tie surface being parallel to the inner radial side of the reel, two ends of the elastic shear tie being extended respectively with an elastic arm, a tail end of the elastic shear tie being fixed and combined in a slot opposite to the access opening, the elastic shear tie acting an elastic force parallel to the axis line of the reel and acting on the wheel surface, and an apex of the elastic shear tie being disposed in tangential to the wheel surface, in adjacent to the inner radial side.

7. The rebound device used in running a pull cord, according to claim 6, wherein the access opening is a space formed by opposite side ends of an upper frame and a lower frame of the retractable unit.

8. The rebound device used in running a pull cord, according to claim 6, wherein the elastic shear tie is combined with the elastic arms to form a U-shaped body.

9. The rebound device used in running a pull cord, according to claim 6, wherein the elastic shear tie is an elastic wire and is integrally bent into a U-shaped half-frame unit.

10. The rebound device used in running a pull cord, according to claim 6, wherein the elastic shear tie is an elastic block, with an arc-shaped apex being made of a wear resistant material.

11. The rebound device used in running a pull cord, according to claim 6, wherein the elastic shear tie is a roller.
